(19) United States
(12) Patent Application Publication
(10) Pub. No.: US 2025/0102322 A1
(43) Pub. Date: Mar. 27, 2025

(54) METHOD FOR ALIGNING MAP SECTIONS OF A DIGITAL ROAD MAP

(71) Applicant: Robert Bosch GmbH, Stuttgart (DE)

(72) Inventors: Andre Wagner, Hannover (DE); Hans-Georg Raumer, Hildesheim (DE); Max Kirstein, Hohenhameln - Ot Bruendeln, (DE); Thomas Wenzel, Hamburg (DE); Thorben Funke, Sarstedt (DE)

(21) Appl. No.: 18/824,029

(22) Filed: Sep. 4, 2024

(30) Foreign Application Priority Data
Sep. 22, 2023 (DE) 10 2023 209 267.0

(51) Int. Cl. G01C 21/00

(52) U.S. Cl. CPC G01C 21/387; G01C 21/3815

(57) ABSTRACT

A method for aligning a first map section of a digital road map with a second map section of the digital road map that at least partially overlaps the first map section. The method includes: determining that a first relative rotation between the two map sections cannot be unambiguously ascertained; ascertaining a second relative rotation between a third map section of the digital road map and a fourth map section of the digital road map that at least partially overlaps the third map section, wherein the third map section and the fourth map section are adjacent to the first map section and to the second map section; aligning the first map section with the second map section; wherein the alignment includes ascertaining a relative rotation between the first map section and the second map section based on the ascertained second relative rotation.

### CROSS REFERENCE

The present application claims the benefit under 35 U.S.C. § 119 of German Patent Application No. DE 10 2023 209 267.0 filed on Sep. 22, 2023, which is expressly incorporated herein by reference in its entirety.

### FIELD

The present invention relates to a method for aligning a first map section of a digital road map with a second map section of the digital road map that at least partially overlaps the first map section, to a device, a computer program and a machine-readable storage medium.

### BACKGROUND INFORMATION

China Patent Application No. CN 1 13 192 142 A describes a map construction method.

China Patent Application No. CN 1 13 066 105 A describes a positioning and mapping system.

China Patent Application No. CN 1 15 077 519 A describes a positioning and mapping method.

With simultaneous localization and mapping (SLAM), sensor data with map data from various trips must regularly be aligned and fused with one another. Especially in automotive-related camera-based SLAM systems, road markings play a crucial role in this respect. They represent a fundamental element in HD mapping due to their good visibility and widespread availability. At the same time, a vehicle can localize itself relatively precisely, mainly laterally, on the basis of the road markings. In order to build maps accurately, it is often not enough to use just one trip along a route; instead, maps are built on the basis of an entire fleet of motor vehicles, so-called crowd-sourced maps. For this purpose, the individual maps created by a motor vehicle are aligned and fused with other maps created by other motor vehicles. However, a fundamental problem in mapping and localization is often that only local sections of the map are used, but only one road marking is recognized in many road regions. This can happen due to errors in perception. However, it may also be that only one road marking exists in a road portion for a longer period of time; for example, the right-hand lane marking is the only road marking on some roads. Since many algorithms in HD (high-definition) road mapping are based on calculating relative rotations and translations between two map sections, the situation in which only one lane marking exists or can be matched is often a critical case. In this case, no unambiguous roll angle can be determined.

### SUMMARY

An object of the present invention is to provide a concept for aligning a first map section of a digital road map with a second map section of the digital road map that at least partially overlaps the first map section.

This object may be achieved according to features of the present invention. Advantageous embodiments of the present invention are disclosed herein.

According to a first aspect of the present invention, a method for aligning a first map section of a digital road map with a second map section of the digital road map that at least partially overlaps the first map section is provided. According to an example embodiment of the present invention, the method includes the following steps:
determining that a first relative rotation between the two map sections cannot be unambiguously ascertained,
ascertaining a second relative rotation between a third map section of the digital road map and a fourth map section of the digital road map that at least partially overlaps the third map section, wherein the third map section and the fourth map section are adjacent to the first map section and to the second map section,
aligning the first map section with the second map section, wherein the alignment comprises ascertaining a relative rotation between the first map section and the second map section on the basis of the ascertained second relative rotation.

According to a second aspect of the present invention, a device is provided, which is configured to perform all steps of the method according to the first aspect of the present invention.

According to a third aspect of the present invention, a computer program is provided, comprising instructions that, when the computer program is executed by a computer, for example by the device according to the second aspect, cause the computer to perform a method according to the first aspect.

According to a fourth aspect of the present invention, a machine-readable storage medium is provided on which the computer program according to the third aspect is stored.

The present invention is based on and includes the knowledge that the above object is achieved in that, if a degenerate situation is present, i.e., if a first relative rotation between the two map sections cannot be unambiguously ascertained, information, in this case the second relative rotation, from adjacent map sections of the two map sections to be aligned is used. According to the present invention described here, the ascertained second relative rotation between the third map section and the fourth map section is thus used to align the first map section with the second map section. The first relative rotation, which could previously not be unambiguously ascertained, is now ascertained by using the ascertained second relative rotation according to the present invention described here.

Even if a degenerate situation is present, the first map section can thus be aligned with the second map section.

A degenerate situation is a situation in which it is determined or decided that a first relative rotation between the two map sections cannot be unambiguously ascertained. This is the case, for example, if only one road marking exists or is recognized in one of the map sections, whereas a plurality of road markings exist in the other of the map sections. This is the case, for example, if only one road marking exists or is recognized in each of the two map sections.

If the relative rotation between the two map sections to be aligned cannot be unambiguously ascertained, a so-called roll angle ambiguity thus exists.

In order to resolve such a roll angle ambiguity, according to an example embodiment of the present invention described here, additional information from adjacent map sections is used: the second relative rotation between the two adjacent map sections, i.e., the roll angle between the two adjacent map sections.

For example, it is provided that the roll angle, i.e., the relative rotation, between the two adjacent map sections is propagated into the two map sections to be aligned.

According to one embodiment of the method of the present invention, it is thus provided that ascertaining the relative rotation between the first map section and the second map section comprises propagating the ascertained second relative rotation into the first and into the second map sections.

This, for example, brings about the technical advantage that the relative rotation between the first map section and the second map section can be ascertained efficiently.

In one embodiment of the method of the present invention, it is provided that a relative delta pose between the first map section and the second map section is ascertained, wherein a set of inliers is ascertained on the basis of the ascertained delta pose, wherein a major axis transformation of the ascertained set of inliers is carried out, wherein it is determined on the basis of the major axis transformation that a first relative rotation between the two map sections cannot be unambiguously ascertained.

This, for example, brings about a technical advantage that the presence of a degenerate situation can be efficiently recognized and determined.

In one example embodiment of the method of the present invention, it is provided that the major axis transformation comprises carrying out a singular value decomposition of the set of inliers in order to ascertain the major axes, wherein it is determined on the basis of the singular value decomposition that a first relative rotation between the two map sections cannot be unambiguously ascertained.

This, for example, brings about a technical advantage that it can be efficiently determined if a degenerate situation is present.

In one example embodiment of the method of the present invention, it is provided that, if two of three singular values ascertained according to the singular value decomposition are less than, or less than or equal to, a predetermined limit, it is decided that all inliers lie on a major axis, wherein it is determined that a first relative rotation between the two map sections cannot be unambiguously ascertained.

This, for example, brings about a technical advantage that a degenerate situation can be efficiently recognized.

In one example embodiment of the method of the present invention, it is provided that the set of inliers is ascertained on the basis of a nearest neighbor heuristic by using a distance limit, by deciding that each point of a lane marking represented by the first map portion is an inlier if there is a point in the second map section that is located within the distance limit to the corresponding point of the lane marking represented by the second map portion.

This, for example, brings about the technical advantage that the set of inliers can be efficiently ascertained.

Device features of the present invention result analogously from corresponding method features of the present invention, and vice versa.

The method of the present invention is, for example, carried out by means of the device.

The method is, for example, a computer-implemented method.

According to an example embodiment of the present invention, an alignment between two map sections comprises, for example, ascertaining a relative delta pose between these two map sections.

A third and/or a fourth map section within the meaning of the description is, for example, a directly adjacent map section in relation to the first map section and/or in relation to the second map section.

For example, it is decided that the relative rotation between the first map section and the second map section is equal to the second relative rotation between the third map section and the fourth map section.

A relative rotation may also be referred to as a roll angle.

Ascertaining a relative delta pose comprises, for example, ascertaining a relative rotation and a relative translation.

A map section within the meaning of the description was or is ascertained, for example, by using environmental sensor data from one or more environmental sensors of a motor vehicle.

An environmental sensor within the meaning of the description is, for example, one of the following environmental sensors: radar sensor, LiDAR sensor, image sensor, in particular an image sensor of a video camera, ultrasonic sensor, infrared sensor, and magnetic field sensor.

A map section within the meaning of the description can thus be generated or created, for example, by using LiDAR data and/or radar data and/or video camera data and/or infrared data and/or magnetic field data and/or ultrasound data.

Environmental sensor data within the meaning of the description describe an environment of the motor vehicle.

A road marking within the meaning of the description is, for example, one of the following road markings: longitudinal marking, area marking, boundary marking, transverse marking, parking area marking.

A road marking may also be referred to as a lane marking.

A longitudinal marking comprises, for example, one of the following longitudinal markings: guiding line, warning line, road boundary, lane boundary, one-sided lane boundary, exit line, double lane boundary.

A longitudinal marking may, for example, comprise the following: a continuous line, an interrupted line, a double line that is both continuous and interrupted, a continuous double line, an interrupted double line.

The exemplary embodiments and embodiments described herein can be combined with one another in any desired manner, even when this is not explicitly described.

The device according to an example embodiment of the present invention is, for example, configured in terms of program technology to execute the computer program.

The present invention is explained in more detail below using preferred exemplary embodiments.

### BRIEF DESCRIPTION OF THE DRAWINGS

FIG. 1 shows a flow chart of a method according to a first aspect of the present invention.

FIG. 2 shows a device according to a second aspect of the present invention.

FIG. 3 shows a machine-readable storage medium according to a fourth aspect of the present invention.

FIG. 4 shows two map sections of a digital road map before an alignment.

FIG. 5 shows the two map sections of FIG. 4 after an alignment.

FIG. 6 shows two map sections of a digital road map before an alignment.

FIG. 7 shows the two map sections of FIG. 6 after an alignment.

FIG. 8 shows two map sections of a digital road map before an alignment.

### DETAILED DESCRIPTION OF EXAMPLE EMBODIMENTS

In the following, the same reference signs can be used for identical features.

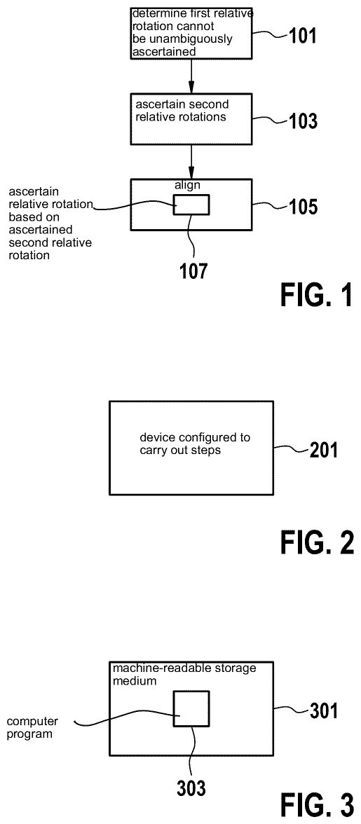

FIG. 1 shows a flow chart of a method for aligning a first map section of a digital road map with a second map section of the digital road map that at least partially overlaps the first map section, comprising the following steps:
determining 101 that a first relative rotation between the two map sections cannot be unambiguously ascertained,
ascertaining 103 a second relative rotation between a third map section of the digital road map and a fourth map section of the digital road map that at least partially overlaps the third map section, wherein the third map section and the fourth map section are adjacent to the first map section and to the second map section,
aligning 105 the first map section with the second map section, wherein the alignment comprises ascertaining 107 a relative rotation between the first map section and the second map section on the basis of the ascertained second relative rotation.

FIG. 2 shows a device 201 which is configured to carry out all steps of the method according to the first aspect.

FIG. 3 shows a machine-readable storage medium 301 on which a computer program 303 is stored. The computer program 303 comprises instructions which, when the computer program 303 is executed by a computer, cause the computer to carry out a method according to the first aspect.

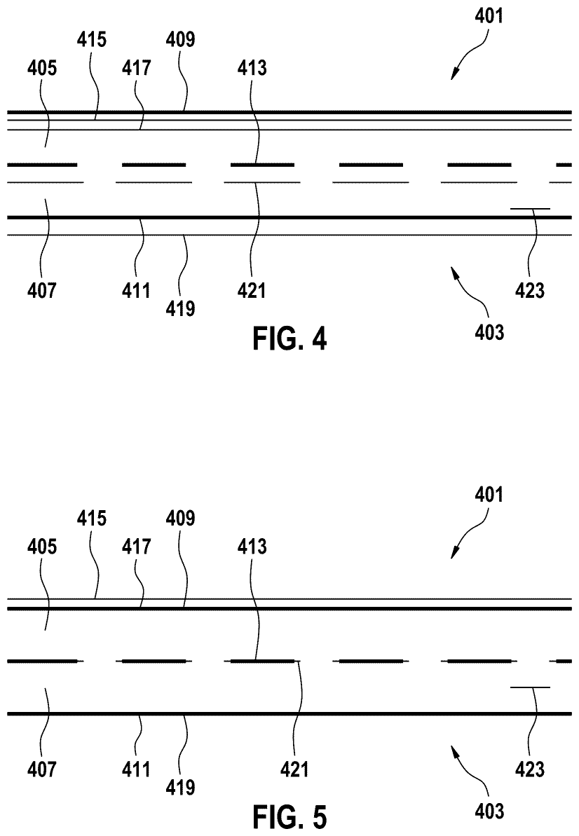

FIG. 4 shows two map sections of a digital road map that are to be aligned. In detail, FIG. 4 shows a first map section 401 and a second map section 403.

The first map section 401 comprises a first road 405. The second map section 403 comprises a second road 407.

The first road 405 has two solid lines 409, 411 as lane boundary markings. Furthermore, a dashed line 413 runs as a center line between the two lane boundaries 409, 411.

For the second map section 403, three solid lines 415, 417, 419 were recognized, as well as a dashed line 421 and a short line 423, which appears to belong to the dashed line 421.

Here, two solid lines 415, 417 are very close to one another.

The solid lines 415, 417 and 419 form boundary lines or lane boundaries of the road 407. The dashed line 421 is a center strip. The short line 423 is, for example, a misrecognition.

By using conventional alignment algorithms, the two map sections can be aligned. This is shown by way of example in FIG. 5.

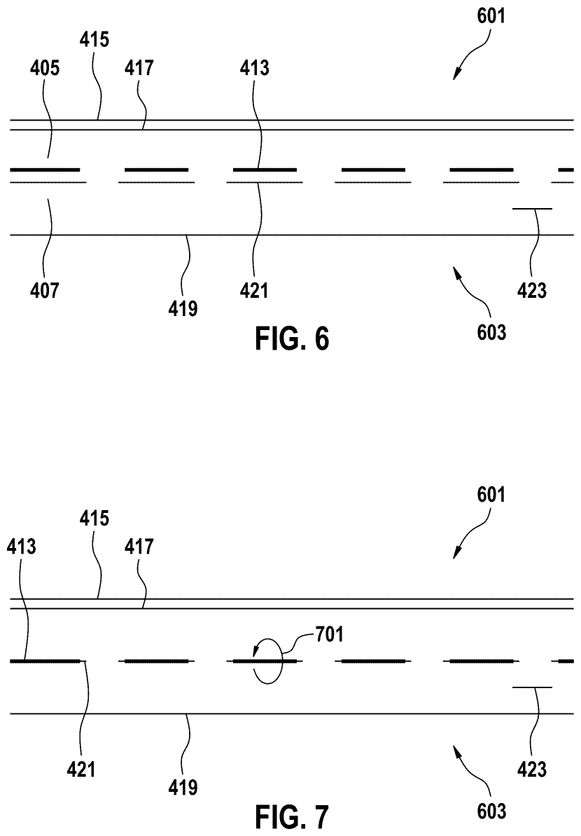

FIG. 6 shows a first map section 601 and a second map section 603 that are to be aligned.

In contrast to the first map section 401 according to FIG. 4, with regard to the first map section 601 of FIG. 6, only the dashed line 413 exists in order to align the two map sections. After aligning the two map sections, as shown in FIG. 7 by way of example, the roll angle cannot be unambiguously determined. The alignment has proven to be degenerate. A degenerate situation is thus present. The roll angle is shown in FIG. 7 by way of example by a circular arrow with reference sign 701.

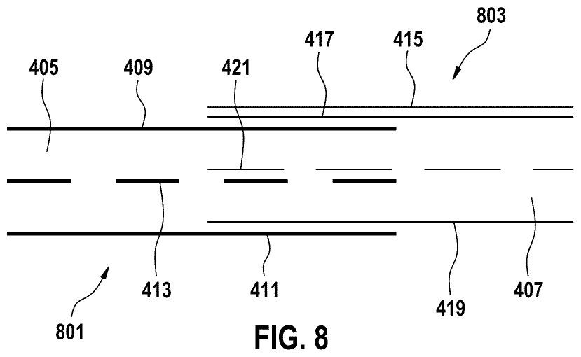

FIG. 8 shows a first map section 801 and a second map section 803, which at least partially overlap so that they can be aligned on the basis of their overlap.

According to the concept described here, if a degenerate situation is present, as shown by way of example in FIG. 6 and FIG. 7, it is provided that information from adjacent map sections is used: the roll angle between the two adjacent map sections.

The concept described here is thus based in particular on recognizing or detecting a degenerate situation.

As part of the alignment, lane markings of the map sections are, for example, associated.

The concept described here thus recognizes degenerate lane associations, in particular line associations, wherein additional information is used to resolve the geometric underdetermination of the problem, i.e., of the association.

Associating may also be referred to as matching.

For example, two map sections are aligned by an algorithm, wherein the respective lane markings, in particular lines, are associated. Such algorithms are conventional. It is in particular provided that it is ascertained, on the basis of this alignment result, whether or not a degenerate situation is present. If such a degenerate situation is present, the associated lane markings lie substantially all on a straight line. For example, it can be determined, on the basis of a major axis analysis, whether a point cloud is very similar to a straight line.

In order to resolve a roll angle ambiguity, an additional piece of information or additional pieces of information from two adjacent map sections that at least partially overlap is/are used, for example. In this case, it is, for example, provided that these two adjacent map sections are aligned, wherein the respective lane markings are, for example, associated as part of the alignment. If a degenerate situation is not present in this case, a correspondingly determined roll angle between these two adjacent map sections can be used to ascertain the roll angle between the map sections to be aligned originally.

For example, it is provided that the inliers are ascertained on the basis of the relative delta pose between the two map sections to be aligned. Inliers are, for example, ascertained on the basis of a nearest neighbor heuristic, in particular by using a distance limit. This means that any point (of a line) from the first map section counts as an inlier if there is a point in the second map section that is close enough to the point of the second map. Now, for example, the set of all inliers is considered. The major axes are, for example, calculated on the basis of the set of all inliers. The major axes may, for example, be estimated via a singular value decomposition. For example, if two of the three singular values are very small, then all inliers lie on one axis and the situation is degenerate.

If a degenerate situation is recognized, it is remedied by adding an additional piece of information or additional pieces of information, in particular the second roll angle. In this case, additional adjacent map sections are used. If no degenerate situation is recognized for these adjacent map sections as part of an alignment of these two map sections, the roll angle between the two adjacent map sections can, for example, be propagated into the map section pair with the degenerate alignment. In order to make this possible, to be able to further propagate the roll angle, it is provided, for example, that the adjacent map sections lie within the same digital road map. For example, the adjacent map sections within the same road map with a sufficient overlap are used. If the digital road map was or is generated by means of additional information, such as inertial sensors, odometry, etc., this additional information can, for example, also be used to ascertain the relative rotation between the first and second map sections, i.e., to propagate the second roll angle, for example.

The concept described here is not necessarily focused on lines; point-like features, such as posts or planes, etc. can also be used for the alignment. A mixed use of geometry types is provided, for example.

The map sections may, for example, be generated from camera data and may, for example, also be generated in addition or instead from data from other environmental sensors, for example also LiDAR sensors or radar sensor and/or other environmental sensors, as already described above.

What is claimed is:

1. A method for aligning a first map section of a digital road map with a second map section of the digital road map that at least partially overlaps the first map section, the method comprising the following steps:
determining that a first relative rotation between the first map section and the second map section cannot be unambiguously ascertained;
ascertaining a second relative rotation between a third map section of the digital road map and a fourth map section of the digital road map that at least partially overlaps the third map section, wherein the third map section and the fourth map section are adjacent to the first map section and to the second map section; and
aligning the first map section with the second map section, wherein the alignment includes ascertaining a relative rotation between the first map section and the second map section based on the ascertained second relative rotation.

2. The method according to claim 1, wherein the ascertaining of the relative rotation between the first map section and the second map section includes propagating the ascertained second relative rotation into the first map section and into the second map section.

3. The method according to claim 1, wherein a relative delta pose between the first map section and the second map section is ascertained, wherein a set of inliers is ascertained based on the ascertained delta pose, wherein a major axis transformation of the ascertained set of inliers is carried out, wherein it is determined based on the major axis transformation that a first relative rotation between the two map sections cannot be unambiguously ascertained.

4. The method according to claim 3, wherein the major axis transformation includes carrying out a singular value decomposition of the set of inliers to ascertain major axes, wherein it is determined based on the singular value decomposition that a first relative rotation between the first map section and the second map section cannot be unambiguously ascertained.

5. The method according to claim 4, wherein, when two of three singular values ascertained according to the singular value decomposition are less than, or less than or equal to, a predetermined limit, it is decided that all inliers lie on a major axis, wherein it is determined that a first relative rotation between the first map section and the second map section cannot be unambiguously ascertained.

6. The method according to claim 3, wherein the set of inliers is ascertained based on a nearest neighbor heuristic by using a distance limit, by deciding that each point of a lane marking represented by the first map portion is an inlier when there is a point in the second map section that is located within the distance limit to a corresponding point of the lane marking represented by the second map portion.

7. A device configured to align a first map section of a digital road map with a second map section of the digital road map that at least partially overlaps the first map section, the device configured to:
determine that a first relative rotation between the first map section and the second map section cannot be unambiguously ascertained;
ascertain a second relative rotation between a third map section of the digital road map and a fourth map section of the digital road map that at least partially overlaps the third map section, wherein the third map section and the fourth map section are adjacent to the first map section and to the second map section; and
align the first map section with the second map section, wherein the alignment includes ascertaining a relative rotation between the first map section and the second map section based on the ascertained second relative rotation.

8. A non-transitory machine-readable storage medium on which is stored a computer program for aligning a first map section of a digital road map with a second map section of the digital road map that at least partially overlaps the first map section, the computer program, when executed by a computer, causing the computer to perform the following steps:
determining that a first relative rotation between the first map section and the second map section cannot be unambiguously ascertained;
ascertaining a second relative rotation between a third map section of the digital road map and a fourth map section of the digital road map that at least partially overlaps the third map section, wherein the third map section and the fourth map section are adjacent to the first map section and to the second map section; and
aligning the first map section with the second map section, wherein the alignment includes ascertaining a relative rotation between the first map section and the second map section based on the ascertained second relative rotation.
